(19) United States
(12) Patent Application Publication
(10) Pub. No.: US 2026/0143295 A1
(43) Pub. Date: May 21, 2026

(54) MICRO SPEAKER STRUCTURE AND METHOD FOR FORMING THE SAME

(71) Applicant: Fortemedia, Inc., Alviso, CA (US)

(72) Inventors: Bin-Rong LI, Taipei City (TW); Yu-Xuan XU, Hsinchu City (TW); Shih-Chin GONG, Taipei City (TW); Yung-Wei CHEN, Hsinchu City (TW); Shih-Chung WANG, Hsinchu City (TW)

(21) Appl. No.: 18/952,181

(22) Filed: Nov. 19, 2024

(51) Int. Cl. H04R 31/00; H04R 7/02

(52) U.S. Cl. CPC H04R 31/00; H04R 7/02

(57) ABSTRACT

A micro speaker structure and a method of forming the same are provided. The micro speaker structure includes a substrate having a hollow chamber. A diaphragm is disposed over the substrate and covers the hollow chamber. A coil is embedded in the diaphragm. A circuit board is disposed on the bottom surface of the substrate. A permanent magnetic element is disposed on the circuit board and in the hollow chamber. A magnetic conductive element is disposed on the circuit board and surrounds the permanent magnetic element, wherein the magnetic conductive element is a metal ring with magnetic permeability.

### BACKGROUND OF THE INVENTION

### Field of the Invention

The invention relates in general to a micro speaker structure, and in particular to a micro speaker structure and a method for forming the same.

### Description of the Related Art

Since electronic products are becoming smaller and thinner, how to scale down the size of electronic products has become an important topic. Micro electromechanical system (MEMS) technology is a technology that combines semiconductor processing and mechanical engineering, which can effectively reduce the size of components and produce multi-functional micro elements and micro systems.

The manufacturing of traditional moving coil speakers has become quite mature, but traditional moving coil speakers have a large size and take up a lot of space. If the MEMS process is used to manufacture a moving coil speaker on a semiconductor chip, its size and volume will be reduced. However, in addition to the need to reduce the size to facilitate manufacturing, it is still necessary to develop a micro speaker with better performance.

### BRIEF SUMMARY OF THE INVENTION

An embodiment of the invention provides a micro speaker structure. The micro speaker structure includes a substrate, a diaphragm, a coil, a circuit board, a first permanent magnetic element, and a magnetic conductive element. The substrate has a hollow chamber. The diaphragm is disposed over the substrate and covers the hollow chamber. The coil is embedded in the diaphragm. The circuit board is disposed on the bottom surface of the substrate. The first permanent magnetic element is disposed on the circuit board and in the hollow chamber. The magnetic conductive element is disposed on the circuit board and surrounds the permanent magnetic element, wherein the magnetic conductive element is a metal ring with magnetic permeability.

In some embodiments, the thickness of the magnetic conductive element is equal to the thickness of the first permanent magnetic element.

In some embodiments, the inner diameter of the magnetic conductive element is larger than the diameter of the first permanent magnetic element.

In some embodiments, the inner diameter of the magnetic conductive element is equal to the diameter of the first permanent magnetic element, and the magnetic conductive element is in contact with the first permanent magnetic element.

In some embodiments, the magnetic conductive element partially overlaps the coil in a plan view.

In some embodiments, the top surface of the magnetic conductive element and the top surface of the first permanent magnetic element are at the same level.

In some embodiments, the magnetic conductive element includes a first portion and a second portion connected to the first portion, wherein the second portion is closer to the first permanent magnetic element than the first portion, and the thickness of the second portion is less than the thickness of the first portion.

In some embodiments, the magnetic conductive element includes a first portion, a second portion, and a third portion, wherein the second portion is closer to the first permanent magnetic element than the first portion, the bottom of the first portion is vertically spaced apart from the circuit board, and the third portion connects the bottom of the first portion to the top of the second portion.

In some embodiments, the third portion of the magnetic conductive element is curved in cross-sectional view.

In some embodiments, the magnetic conductive element includes a first portion and a second portion connected to the first portion, wherein the second portion is closer to the first permanent magnetic element than the first portion, and the thickness of the first portion is less than the thickness of the second portion.

In some embodiments, the micro speaker structure further includes an adhesive material disposed in the gap between the outer sidewall of the first permanent magnetic element and the magnetic conductive element.

In some embodiments, the circuit board has a cavity recessed from the top surface of the circuit board, wherein the cavity is configured to accommodate the first permanent magnetic element and the magnetic conductive element.

In some embodiments, the circuit board has at least one vent hole passing through the top surface and the bottom surface of the circuit board.

In some embodiments, the micro speaker structure further includes a lid wrapped around the substrate and the diaphragm, wherein the lid has an air opening that exposes a portion of the top surface of the diaphragm.

In some embodiments, the micro speaker structure further includes a second permanent magnetic element disposed on the lid, wherein the second permanent magnetic element is located below or above the air opening.

In some embodiments, the coil includes a first metal layer and a second metal layer, wherein the first metal layer has a spiral structure surrounding the central axis of the diaphragm, and the second metal layer crosses over the spiral structure of the first metal layer and is electrically connected to the first metal layer.

Another embodiment of the invention provides a method for forming a micro speaker structure. The method includes forming a coil on a substrate. The method includes forming a diaphragm on the substrate to cover the coil. The method includes forming a hollow chamber in the substrate, so that the coil structure is aligned with the hollow chamber in a plan view. The method includes attaching a circuit board to the bottom surface of the substrate, wherein a permanent magnetic element is mounted on the circuit board and positioned in the hollow chamber. The method includes placing a magnetic conductive element on the circuit board to surround the permanent magnetic element, wherein the magnetic conductive element is a metal ring with magnetic permeability.

In some embodiments, the magnetic conductive element is placed on the circuit board so that the magnetic conductive element partially overlaps the coil in a plan view.

In some embodiments, the magnetic conductive element is placed on the circuit board so that the magnetic conductive element is laterally spaced apart from the permanent magnetic element.

In some embodiments, the magnetic conductive element is placed on the circuit board so that the top surface of the magnetic conductive element and the top surface of the permanent magnetic element are at the same level.

### BRIEF DESCRIPTION OF DRAWINGS

Aspects of this disclosure are best understood from the following detailed description when read with the accompanying figures. It should be noted that, in accordance with common practice in the industry, various features are not drawn to scale. In fact, the dimensions of the various features may be arbitrarily increased or reduced for clarity of discussion.

FIG. 1 is a schematic top view of a micro speaker structure, in accordance with some embodiments.

FIG. 2 is a schematic cross-sectional view of the micro speaker structure shown in FIG. 1, in accordance with some embodiments.

FIG. 3 is an enlarged view of the area I shown in FIG. 1, in accordance with some embodiments.

FIG. 4 is a schematic top view showing the arrangement of the coil, the first permanent magnetic element, and the magnetic conductive element shown in FIG. 2.

FIGS. 5A to 5G illustrate cross-sectional views of intermediate stages in the formation of a micro speaker structure, in accordance with some embodiments.

FIG. 6 is a schematic cross-sectional view of a micro speaker structure, in accordance with some embodiments.

FIGS. 7A to 7I are schematic cross-sectional view of magnetic conductive elements with various cross-sectional shapes and/or configurations, in accordance with some embodiments.

### DETAILED DESCRIPTION OF INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device (or structure) in use or operation in addition to the orientation depicted in the figures. The device may be otherwise oriented (rotated 90 degrees or at other orientations) and the spatially relative descriptors used herein may likewise be interpreted accordingly.

Terms such as “about” and “substantially,” and the like may be used herein for ease of description. A person having ordinary skill in the art will be able to understand and derive meanings for such terms. For example, the term “about” may indicate variation in a dimension of 20%, 10%, 5%, or the like, but other values may be used when appropriate. The term “substantially” is generally more stringent than “about,” such that variation of 10%, 5% or less may be appropriate, without limit thereto. A feature that is “substantially planar” may have variation from a straight line that is within 10% or less. Again, a person having ordinary skill in the art will be able to understand and derive appropriate meanings for such terms based on knowledge of the industry, current fabrication techniques, and the like.

The use of ordinal terms such as “first”, “second”, “third”, etc., in the disclosure to modify an element does not by itself connote any priority, precedence, or order of one claim element over another or the temporal order in which it is formed, but are used merely as labels to distinguish one claim element having a certain name from another element having the same name (but for use of the ordinal term) to distinguish the claim elements.

Unless defined otherwise, all terms (including technical and scientific terms) used herein have the same meaning as commonly understood to one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise. For example, the term “permanent magnetic element” used herein refers to an element that can maintain magnetism for a long time. That is, the permanent magnetic element is not easy to lose magnetism and is not easy to be magnetized. In addition, permanent magnetic elements can also be referred to as “hard magnetic elements.”

Some embodiments of the present disclosure provide a micro speaker structure that may include a magnetic conductive element to enhance the horizontal or planar magnetic field (i.e., the horizontal component of the magnetic field lines) passing through the coil. This enables the diaphragm embedding the coil to have a better frequency response, thereby improving the performance (e.g., sound pressure level (SPL)) of the micro speaker structure. In some embodiments, the annular magnetic conductive element is placed on the circuit board (such as under the diaphragm) and surrounds a permanent magnetic element thereon. The formation process of the micro speaker structure is also described below.

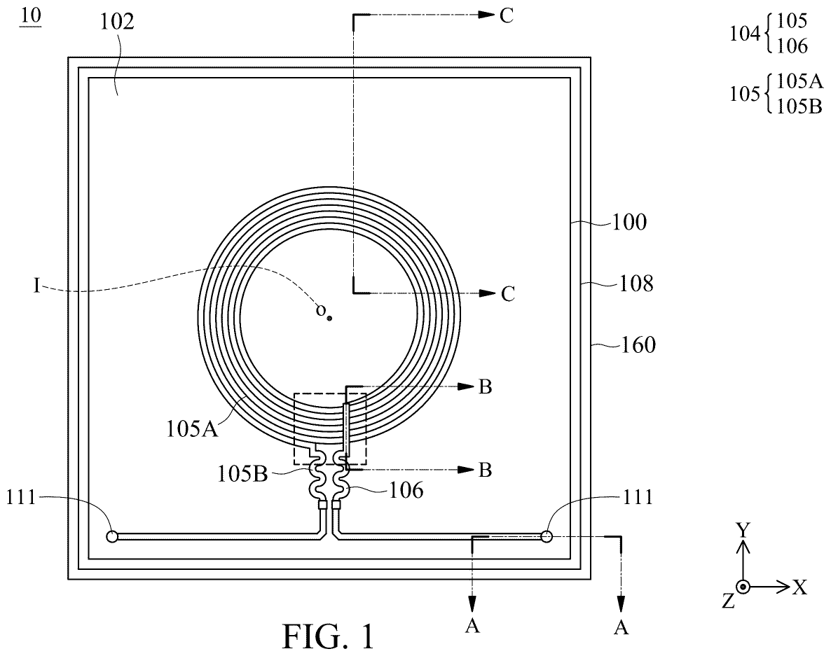

FIG. 1 is a schematic top view of a micro speaker structure 10, in accordance with some embodiments. The micro speaker structure 10 is an electroacoustic transducer, such as a micro moving coil speaker, and may be disposed in general electronic products. As shown in FIG. 1, the micro speaker structure 10 includes a substrate 100, a diaphragm 102, a (multi-layered) coil 104, a lid 108, and a circuit board 160. It should be noted that in FIG. 1, the diaphragm 102 and the lid 108 are only represented by rectangles in order to show the internal structure of the micro speaker structure 10. In addition, some elements of the micro speaker structure 10, as described in greater detail below, are not shown in FIG. 1 to simplify the drawing.

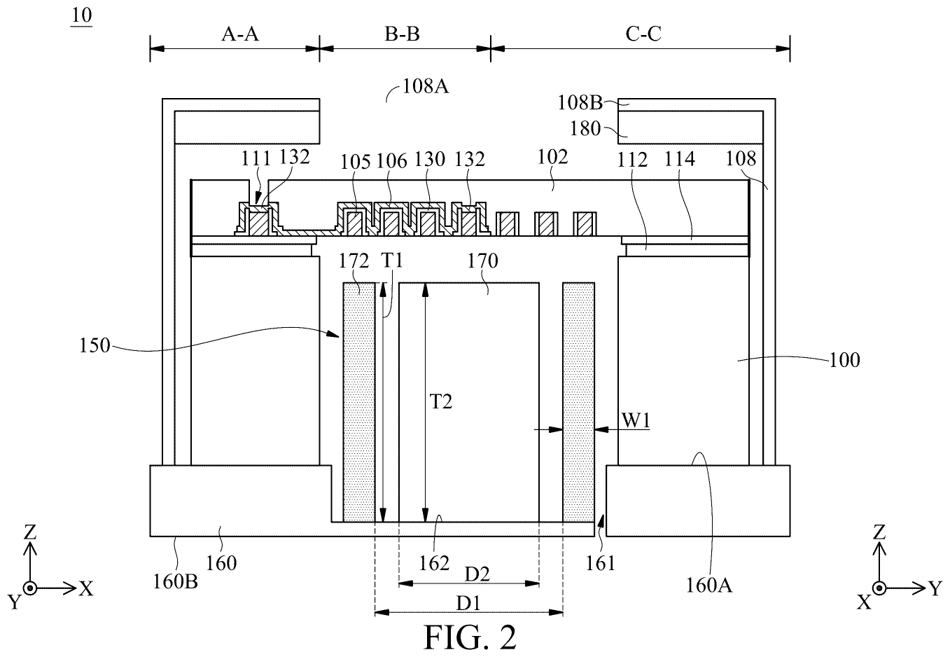

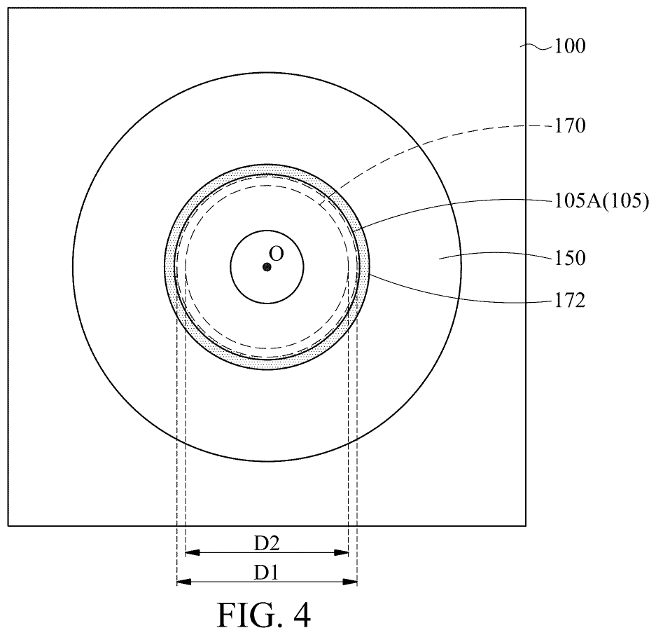

FIG. 2 is a schematic cross-sectional view of the micro speaker structure 10 shown in FIG. 1, in accordance with some embodiments. As shown in FIG. 2, a hollow chamber 150 is formed in the substrate 100. The hollow chamber 150 may have a circular shape in plan (e.g., top) view (e.g., see FIG. 4). The diaphragm 102 is disposed above the substrate 100 and can elastically deform (e.g., oscillate) in the normal direction of the substrate 100 (e.g., the Z-axis direction). For example, the diaphragm 102 includes a central portion (sometimes also referred as the movable portion) disposed (e.g., suspended) above the hollow chamber 150 of the substrate 100 and a peripheral portion (sometimes also referred as the fixed portion) surrounding the central portion and attached (e.g., fixed) to the substrate 100.

The multi-layered coil 104 is embedded in the diaphragm 102, which means that the multi-layered coil 104 is not exposed. Specifically, the multi-layered coil 104 is embedded in the central portion of the diaphragm 102 and aligned with the hollow chamber 150 when viewed from the top (e.g., see FIG. 4). The multi-layered coil 104 is configured to transmit electric signals from a control unit (not shown), and drives the diaphragm 102 to deform relative to the substrate 100 according to the electric signals. At present, resistances of speakers are mostly 8Ω or 32Ω, which is lower than that of single-layer coils. The multi-layered coils of the present disclosure can easily meet the resistance requirements.

Referring to FIGS. 1 and 2, the multi-layered coil 104 includes a first metal layer 105 and a second metal layer 106. The first metal layer 105 is electrically connected to the second metal layer 106 in one opening 111 of the diaphragm 102 to transmit the electrical signals that control the operation of the micro speaker structure 10. In some embodiments, the first metal layer 105 includes a spiral structure 105A located in the center of the diaphragm 102 and a wavy structure 105B extending from the spiral structure 105A to the periphery of the diaphragm 102. The spiral structure 105A is disposed around the central axis O of the diaphragm 102, and the wavy structure 105B connects the spiral structure 105A to the opening 111. By providing the wavy structure 105B, the diaphragm 102 can be more flexible, and the difficulty of the oscillation can be reduced. In some cases, the second metal layer 106 may also include a wavy structure.

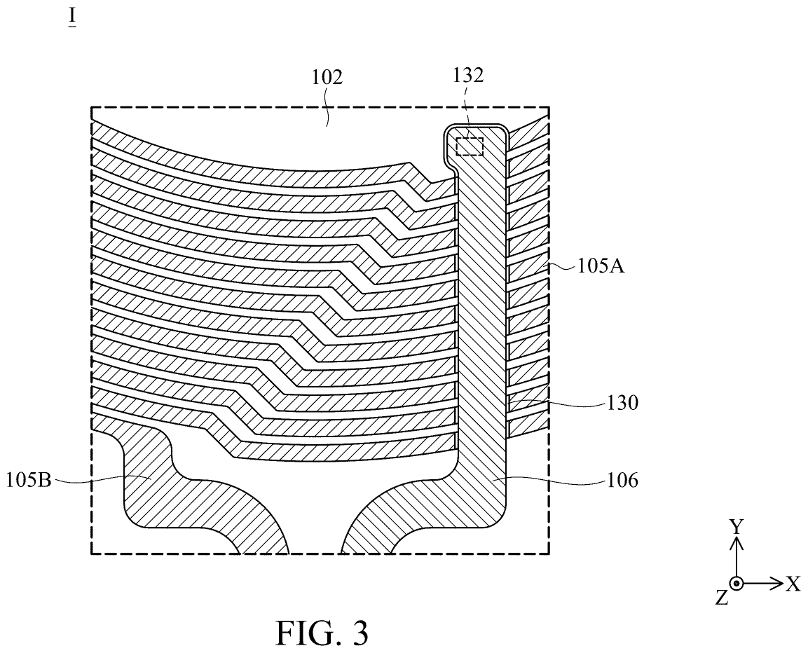

FIG. 3 illustrates an enlarged view of the area I shown in FIG. 1, in accordance with some embodiments. As shown in FIGS. 2 and 3, the first metal layer 105 and the second metal layer 106 are located on different horizontal planes parallel to the X-Y plane, and the second metal layer 106 is higher than the first metal layer 105. That is, the second metal layer 106 is closer to the top of the diaphragm 102 than the first metal layer 105. A dielectric layer 130 may be disposed between the first metal layer 105 and the second metal layer 106 to prevent a short circuit between the first metal layer 105 and the second metal layer 106. A conductive via 132 is formed in the dielectric layer 130. The second metal layer 106 crosses over the spiral structure 105A and is electrically connected to the first metal layer 105 through the conductive via 132.

Referring back to FIG. 2, the micro speaker structure 10 also includes a first permanent magnetic element 170 disposed below the diaphragm 102, in accordance with some embodiments. The first permanent magnetic element 170 is configured to improve the frequency response of the diaphragm 102, which will be described in more detail below.

The above-mentioned components of the micro speaker structure 10 may be disposed above the circuit board 160 (e.g., a printed circuit board (PCB)). The circuit board 160 is configured to provide control electrical signals from the control unit to the coil 104. In addition, the circuit board 160 may have at least one vent hole 161 that allows the interior space of the micro speaker structure 10 (e.g., the hollow chamber 150 between the diaphragm 102 and the circuit board 160) to communicate with the external environment.

The lid 180 (sometimes also called a package lid) is attached to the circuit board 160 and wraps around the various components mentioned above for protection. The lid 180 may have an air opening 108A to allow acoustic energy due to vibration of the diaphragm 102 to travel out of the micro speaker structure 10. In some embodiments, another permanent magnetic element (e.g., second permanent magnetic element 180) may also be provided above the diaphragm 102 and secured to the lid 180 to further improve the frequency response of the diaphragm 102, which will be described in more detail below.

As further shown in FIG. 2, the micro speaker structure 10 also includes a magnetic conductive element 172 disposed on the circuit board 160 (such as under the diaphragm 102 embedding the coil 104) and surrounding the first permanent magnetic element 170, in accordance with some embodiments. In this way, the magnetic conductive element 172 helps to constrain or concentrate the magnetic field (or magnetic field lines) generated by the first permanent magnetic element 170 near the coil 104, thereby enhancing the horizontal or planar magnetic field (i.e., the horizontal component of the magnetic field lines) passing through the coil 104, as mentioned above. This enables the diaphragm 102 embedding the coil 104 to have a better frequency response, thereby improving the performance (e.g., SPL) of the micro speaker structure 10.

In some embodiments, the magnetic conductive element 172 has a ring-shaped structure when viewed from the top (e.g., see FIG. 4). In cross-sectional view, the magnetic conductive element 172 has a consistent width W1 from top to bottom thereof, as shown in FIG. 2, but embodiments of the present disclosure are not limited thereto (some variants of some embodiments will be described below). In some embodiments, the thickness T1 (e.g., in the Z-axis direction) of the magnetic conductive element 172 (e.g., in the Z-axis direction) is substantially equal to the thickness T2 of the first permanent magnetic element 170, so that the top surface of the magnetic conductive element 172 and the top surface of the first permanent magnetic element 170 are at the substantially same level when they are placed on the circuit board 160, for example. This helps to constrain or concentrate the magnetic field (or magnetic field lines) generated by the first permanent magnetic element 170 near the coil 104 through the magnetic conductive element 172.

FIG. 4 is a schematic top view showing the arrangement of the coil 104 (e.g., the spiral structure 105A of the first metal layer 105), the first permanent magnetic element 170, and the magnetic conductive element 172 shown in FIG. 2. It should be noted that for simplicity, the coil is only shown as a ring structure. As shown in FIGS. 2 and 4, the inner diameter D1 of the magnetic conductive element 172 may be larger than the diameter D2 of the first permanent magnetic element 170, so that the magnetic conductive element 172 is laterally spaced apart from the first permanent magnetic element 170 (i.e., they do not come into contact with each other), but embodiments of the present disclosure are not limited thereto (some variants of some embodiments will be described below).

In some embodiments, the magnetic conductive element 172 partially overlaps the coil 104 in a plan view to enhance the horizontal or planar magnetic field (i.e., the horizontal component of the magnetic field lines) passing through the coil 104. For example, a portion (e.g., the inner peripheral portion) of the magnetic conductive element 172 overlaps the coil 104 while other portions (e.g., the outer peripheral portion) of the magnetic conductive element 172 does not overlap the coil 104 when viewed from the top, as shown in FIG. 4. Other arrangements of the magnetic conductive element 172 and coil 104 in a plan view may be possible.

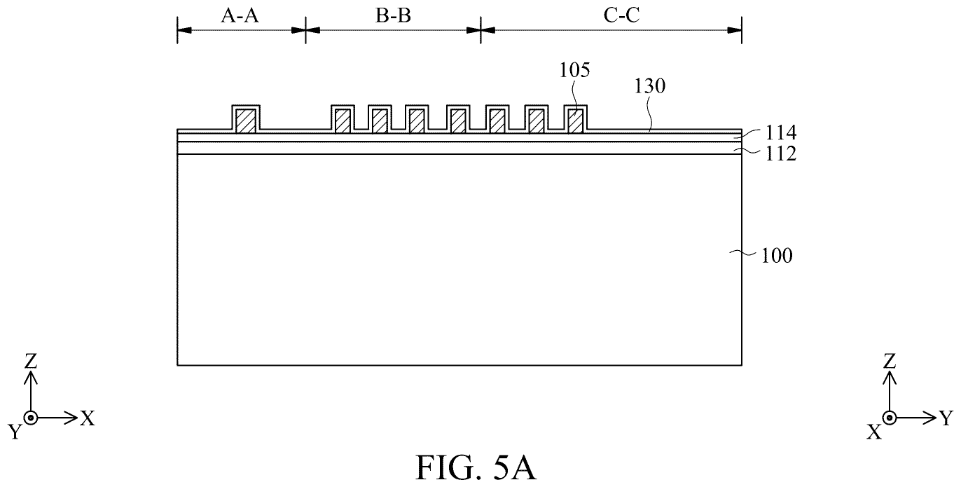

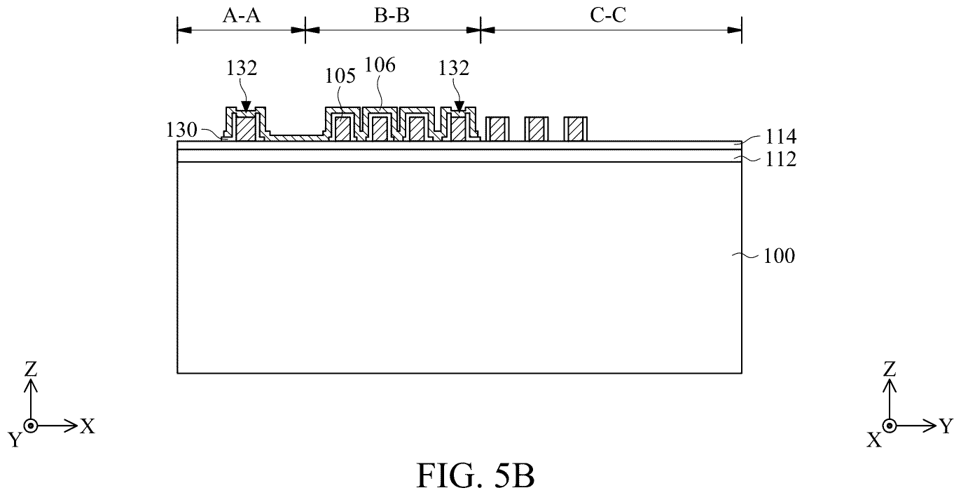

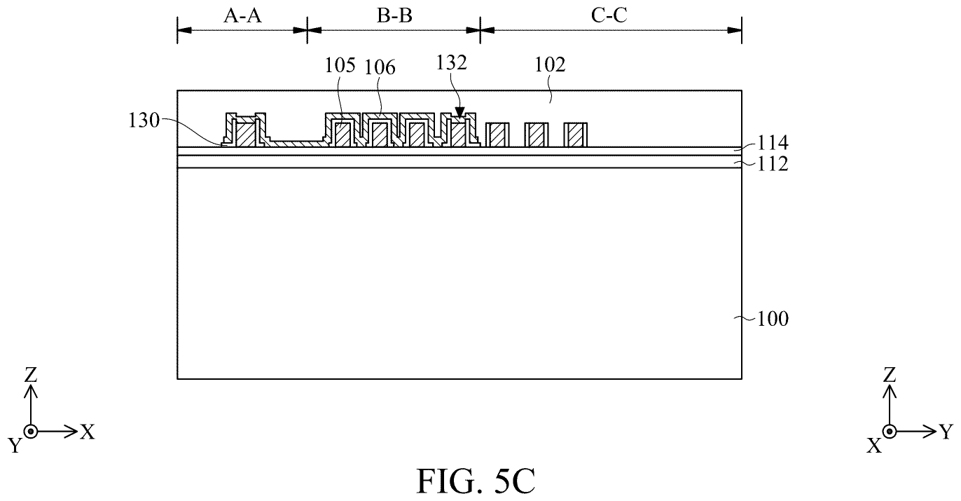

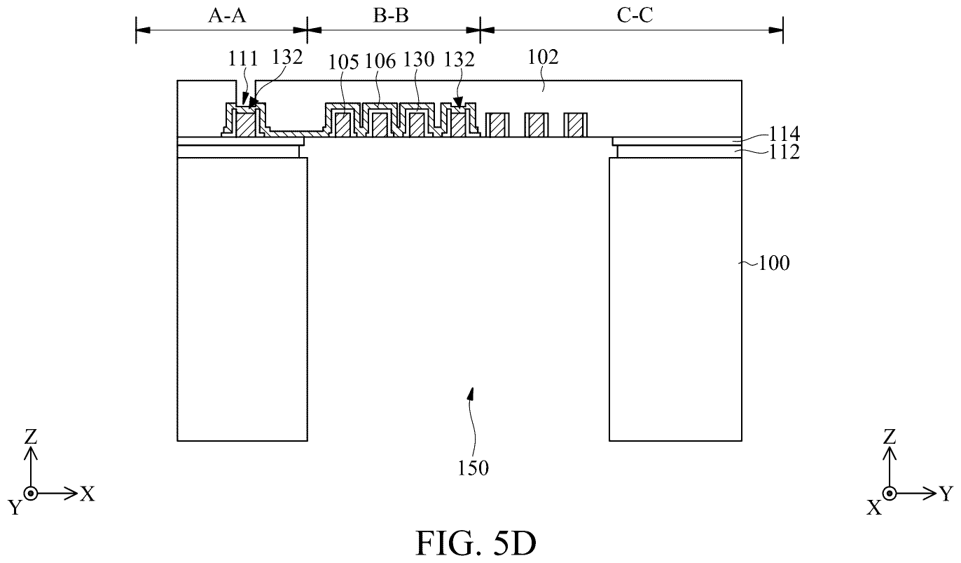

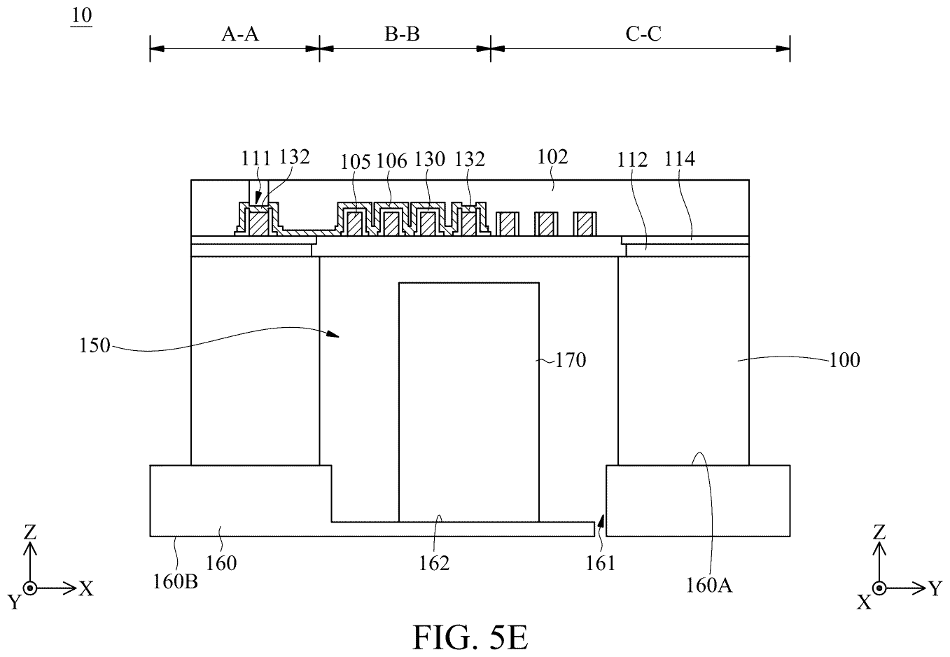

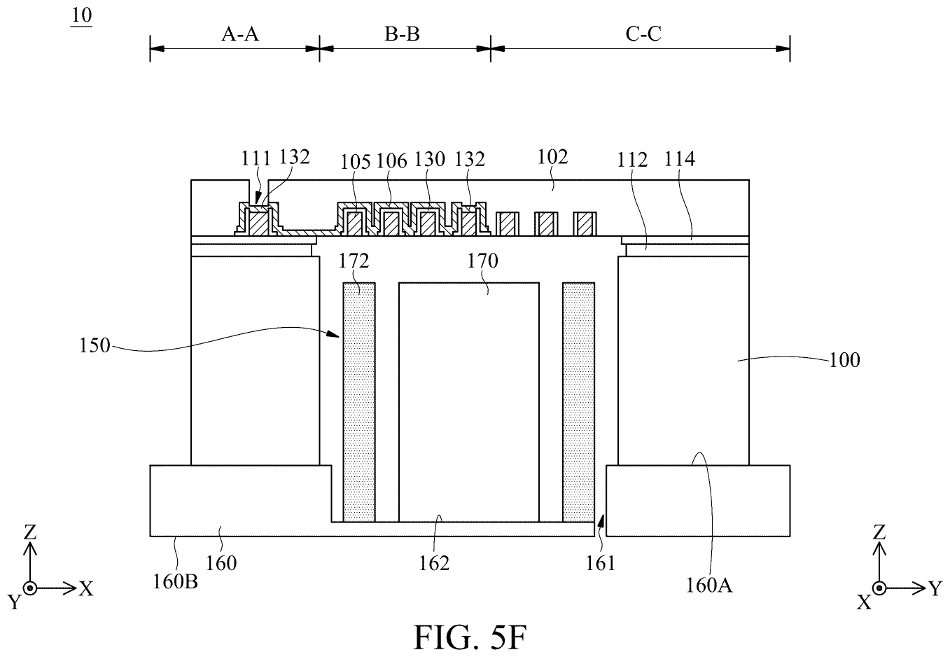

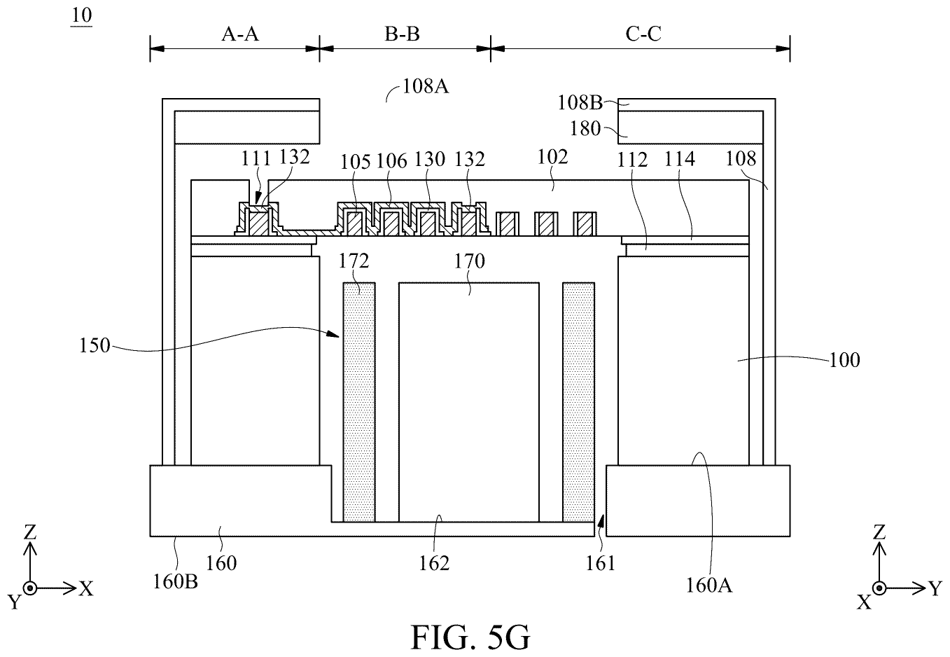

FIGS. 5A to 5G illustrate cross-sectional views of intermediate stages in the formation of a micro speaker structure (e.g., the above-mentioned micro speaker structure 10), in accordance with some embodiments. It should be understood that each of the figures includes cross-sectional views along lines A-A, B-B, and C-C shown in FIG. 1. In this way, the fabrication processes of different parts of the micro speaker structure 10 can be shown in a single figure. Two sets of coordinate axes are provided in FIGS. 5A to 5G, wherein one set of coordinate axes in the left-hand side correspond the cross-sectional view along line A-A, and the other set of coordinate axes in the right-hand side correspond the cross-sectional views along lines B-B and C-C.

Referring to FIG. 5A, a substrate 100 is first provided. In some embodiments, the substrate 100 is part of a semiconductor wafer, and may be formed of silicon (Si). Alternatively, the substrate 100 may include other semiconductor materials, such as germanium; a compound semiconductor including silicon carbide (SiC), gallium arsenic (GaAs), gallium phosphide (GaP), gallium nitride (GaN), indium phosphide (InP), and/or indium arsenide (InAs); an alloy semiconductor including SiGe, SiGeC, GaAsP, GaInAs, and/or InGaP; or combinations thereof. In some embodiments, the thickness (e.g., in the Z-axis direction) of the substrate 100 may be between about 100 microns (μm) and about 1000 μm.

Two dielectric or insulating layers 112, 114 are formed on the substrate 100, wherein the insulating layer 112 is disposed between the insulating layer 114 and the substrate 100. Each of the insulating layers 112 and 114 may be made of or include silicon dioxide (SiO₂) or another suitable insulating material, and may be formed by thermal oxidation, chemical vapor deposition (CVD), low pressure CVD (LPCVD), atmospheric pressure CVD (APCVD), plasma-enhanced CVD (PECVD), or any other suitable process.

The first metal layer 105 of the multi-layered coil 104 is then formed on the insulating layer 114 using electroplating or other deposition processes such as physical vapor deposition (PVD), sputtering or evaporation. The material of the first metal layer 105 may include aluminum silicon alloy, aluminum, copper, or any other suitable conductive material. Next, a patterning process (e.g., including a photolithography process and/or an etching process) is performed on the first metal layer 105, generating the spiral structure 105A and the wavy structure 105B as shown in FIG. 1. In some embodiments, the line width (e.g., in the X-Y plane) of the first metal layer 105 may be between 1 μm and 500 μm, and the thickness (e.g., in the Z-axis direction) of the first metal layer 105 may be between 0.1 μm and 20 μm.

In some embodiments, an etch stop metal layer (not shown) may also be formed on the insulating layer 114 before the first metal layer 105 is formed. The etch stop metal layer may be made of or include aluminum, copper, aluminum-copper alloy, aluminum-silicon alloy, aluminum-silicon-copper alloy, or another suitable metal material that can protect the subsequently formed multi-layered coil 104 from being etched during a subsequent etching process of the substrate 100 (e.g., see FIG. 5D). The etch stop metal layer may be formed by electroplating or another deposition process, such as physical vapor deposition (PVD), sputtering, or evaporation. A patterning process (not specifically shown) may be performed on the etch stop metal layer such that the remainder of the patterned etch stop metal layer is located directly beneath the subsequently formed multi-layered coil 104 and overlaps the multi-layered coil 104 in a plan view. The patterning process may include photolithography processes, etching processes, other suitable processes, or a combination thereof.

After the above patterned first metal layer 105 is formed, a dielectric layer 130 is conformally formed on the patterned first metal layer 105, the patterned etch stop metal layer (if present), and the insulating layer 114 by furnace process, CVD or another suitable deposition process. The dielectric layer 130 may be a carbon-doped oxide or any other suitable insulating material.

Next, in FIG. 5B, the dielectric layer 130 is patterned (e.g., through a photolithography process and an etching process, not specifically shown) to form through holes in the dielectric layer 130 to expose the underlying first metal layer 105.

Subsequently, the second metal layer 106 of the multi-layered coil 104 is formed on the dielectric layer 130 and the first metal layer 105 using electroplating or another deposition process, such as PVD, sputtering, or evaporation. In some embodiments, the material of the second metal layer 106 includes aluminum silicon alloy, aluminum, copper, or another suitable conductive material. A patterning process (e.g., including a photolithography process and an etching process, not specifically shown) is then performed on the second metal layer 106, thereby leaving portions located on the dielectric layer 130 and in the through holes (thereby forming the conductive vias 132). In some embodiments, the line width (e.g., in the X-Y plane) of the second metal layer 106 may be between about 1 μm and about 500 μm, and the thickness (e.g., in the Z-axis direction) of the second metal layer 106 may be between about 0.1 μm and about 20 μm.

It should be noted that the patterned dielectric layer 130 only leaves a portion required to electrically insulate the first metal layer 105 (e.g., the spiral structure 105A) and the second metal layer 106. By removing undesired portions of the dielectric layer 130, the diaphragm 102 (see FIG. 5C) can be more flexible, thereby improving the performance of the micro speaker structure 10.

Next, in FIG. 5C, a diaphragm 102 is formed over the above-mentioned structures such that the multi-layered coil 104 (including the first metal layer 105 and the second metal layer 106) and the dielectric layer 130 are embedded in the diaphragm 102 (i.e., they are not exposed). The diaphragm 102 may be formed by spin coating, slot-die coating, blade coating, wire bar coating, gravure coating, spray coating, CVD, another applicable process, or a combination thereof. In some embodiments, the diaphragm 102 may be made of or include a photosensitive or non-photosensitive polymer material. In some cases, the diaphragm 102 is made of or includes polydimethylsiloxane (PDMS), phenolic epoxy resin (such as SU-8), polyimide (PI), or a combination thereof. In an example, the diaphragm 102 is formed of PDMS, and the Young's modulus of the diaphragm 102 is in a range between about 1 MPa and about 100 GPa. Compared with a diaphragm formed of polyimide, the diaphragm 102 formed of PDMS has a smaller Young's modulus and a softer film structure, which makes the diaphragm 102 have a larger displacement, thereby generating a larger sound amplitude.

Next, in FIG. 5D, the diaphragm 102 is patterned to form openings 111 (only one opening 111 is shown) in the diaphragm 102 and cutting grooves (not shown) surrounding the diaphragm 102. In some embodiments where the diaphragm 102 is made of a photosensitive material such as a photosensitive polymer material, the openings 111 and the cutting grooves may be formed by using photolithography and etching techniques. In other embodiments where the diaphragm 102 is made of a non-photosensitive material, the openings 111 and the cutting grooves may be formed by using drilling, cutting, and/or other suitable patterning techniques. The openings 111 may expose the underlying second metal layer 106 such that the first metal layer 105 is electrically connected to the second metal layer 106 in one of the openings 111, as mentioned above. In other words, when viewed along the vertical direction (e.g., the Z-axis direction), one of the openings 111 of the diaphragm 102 and one of the conductive vias 132 may overlap, as shown in FIG. 5D. The cutting grooves facilitate the cutting process (not shown) to separate the micro speaker structures 10 (for the sake of simplicity, only one micro speaker structure 10 is shown in the drawings).

Still referring to FIG. 5D, a deep reactive-ion etching (RIE) process or another etching process which applies an etchant (such as ammonium hydroxide (NH4OH), hydrofluoric acid (HF), deionized water, tetramethylammonium hydroxide (TMAH), potassium hydroxide (KOH)) is performed on the bottom surface of the substrate 100 to form a hollow chamber 150 in the substrate 100. The diaphragm 102 covers (e.g., is suspended over) the hollow chamber 150 after the etching process. It should be noted that the insulating layers 112, 114 and the above patterned etch stop metal layer (if present) may act as etch stop layers during the etching process, thereby protecting the diaphragm 102 and the multi-layered coil 104 from being etched.

Next, in FIG. 5E, a circuit board 160 (such as a PCB) is disposed on (e.g., attached to) the bottom surface of the substrate 100. Therefore, the substrate 100 is located between the circuit board 160 and the diaphragm 102. As mentioned above, the circuit board 160 may have one or more vent holes 161 penetrating its top surface 160A and bottom surface 160B to allow the hollow chamber 150 to communicate with the external environment. In some embodiments, the vent holes 161 may have circular, oval or another suitable cross-sectional shape. The number and position of the vent holes 161 can be selected according to actual requirements (e.g., the desired frequency response curve of the micro speaker structure 10).

Still referring to FIG. 5E, a first permanent magnetic element 170 is disposed on (e.g., attached to) the circuit board 160 and located in the hollow chamber 150, so that the first permanent magnetic element 170 is disposed below the diaphragm 102. The first permanent magnetic element 170 is used to cooperate with the overlying multi-layered coil 104 (i.e., the magnetic field generated by the first permanent magnetic element 170 interacts with a current passing through the multi-layered coil 104) to generate a (Lorentz) force (e.g., Z-axis force) in the normal direction of the diaphragm 102 (i.e., the vertical/Z-axis direction, which is perpendicular to its top surface), and the diaphragm 102 can vibrate/oscillate relative to the substrate 100 due to the force to generate sound. In some embodiments, the first permanent magnetic element 170 may include a neodymium iron boron magnet.

In some embodiments, the circuit board 160 further has a cavity 162 recessed from its top surface 160A for accommodating the first permanent magnetic element 170, as shown in FIG. 5E. This allows the use of a larger (e.g., thicker) magnet (i.e., first permanent magnetic element 170), which can generate larger Lorentz forces, thereby improving the performance (e.g., SPL) of the micro speaker structure 10.

Next, in FIG. 5F, a magnetic conductive element 172 is disposed on (e.g., attached to) the circuit board 160 and located in the hollow chamber 150, so that the magnetic conductive element 172 is disposed below the diaphragm 102 and surrounds the first permanent magnetic element 170. In some embodiments, the material of the magnetic conductive element 172 includes Mu-Metal, silicon steel, ferrite, or any other applicable magnetic conductive metal material. As discussed above, by providing the magnetic conductive element 172, it helps to constrain or concentrate the magnetic field (or magnetic field lines) generated by the first permanent magnetic element 170 near the coil 104, thereby enhancing the horizontal or planar magnetic field (i.e., the horizontal component of the magnetic field lines) passing through the coil 104. In this way, the diaphragm 102 embedding the coil 104 can have a better frequency response, thereby improving the performance (e.g., SPL) of the micro speaker structure 10.

The structure and configuration of the magnetic conductive element 172 have been described above with reference FIGS. 2 and 4, and will not be repeated here. In some embodiments, the thickness (e.g., in the Z-axis direction) of the magnetic conductive element 172 is at least 100 μm or greater (e.g., same thickness as the first permanent magnetic element 170), so that the horizontal or planar magnetic field passing through the coil 104 can be significantly enhanced by it. In some embodiments, the first permanent magnetic element 170 and the magnetic conductive element 172 are both placed in the recess 162 of the circuit board 160, but embodiments of the present disclosure are not limited thereto.

Next, in FIG. 5G, a (package) lid 108 is disposed on (e.g., attached to) the top surface 160A of the circuit board 160 and wraps around the substrate 100 and the diaphragm 102. The lid 108 has an air opening 108A that exposes a portion of the top surface of the diaphragm 102 to allow air to exit the micro speaker structure 10, thereby producing sound. In some embodiments, the lid 108 may be made of or include a metal with magnetic conductive that is lower than 1.25×10⁻⁴ H/m, such as gold (Au), copper (Cu), aluminum (Al), or a combination thereof.

Still referring to FIG. 5G, a second permanent magnetic element 180 is secured to the lid 108, so that the second permanent magnetic element 180 is disposed above the diaphragm 102. In some embodiments, the second permanent magnetic element 180 is ring-shaped and disposed below an end 108B of the lid 108 surrounding the (circular) air opening 108A. The second permanent magnetic element 180 and the first permanent magnetic element 170 can attract each other to increase the deflection of the planar magnetic field. Therefore, the force generated by the current passing through the multilayer coil 104 and the planar magnetic field in the normal direction of the substrate 100 is increased, so that the diaphragm 102 has a better frequency response, thereby improving the performance of the micro speaker structure 10. In some embodiments, the second permanent magnetic element 180 may include a neodymium iron boron magnet.

In some embodiments, the (vertical) distance (e.g., in the Z-axis direction) between the first permanent magnetic element 170 and the second permanent magnetic element 180 may be between 200 μm and 1000 μm. If the distance between the first permanent magnetic element 170 and the second permanent magnetic element 180 is greater than 1000 μm, there may not be sufficient attractive force between the two to increase the deflection of the planar magnetic field, resulting in a smaller frequency response of the micro speaker structure 10, thereby reducing the performance of the micro speaker structure 10. If the distance between the first permanent magnetic element 170 and the second permanent magnetic element 180 is less than 200 μm, when the diaphragm 102 deforms up and down relative to the substrate 100, it may repeatedly contact and strike the first permanent magnetic element 170 and the second permanent magnetic element 180, which causes damage to the micro speaker structure 10, thereby reducing the reliability of the micro speaker structure 10.

After completing the formation processes shown in FIGS. 5A to 5G, the micro speaker structure 10 can be obtained. It should be understood that since the above-mentioned formation method introduces the magnetic conductive element (e.g., 172) during the packaging process and does not use other complicated process methods (such as electroplating) to form the magnetic conductive element, the manufacturing cost is lower and the time required is also shorter. In addition, the thickness of the magnetic conductive element (e.g., 172) used can be thicker (e.g., thickness of at least 100 μm or greater) without being limited by the electroplating process.

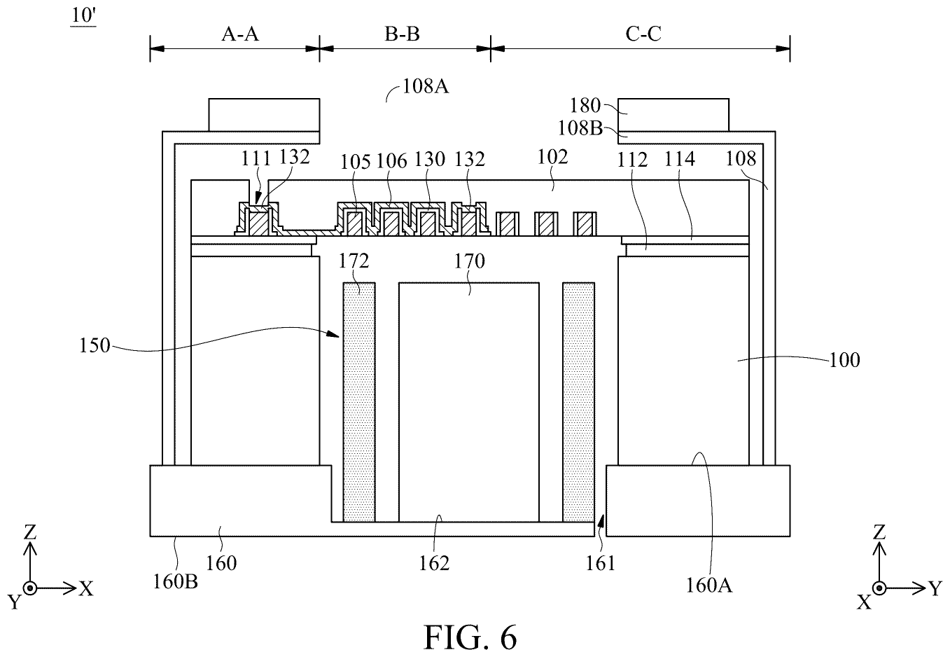

FIG. 6 is a schematic cross-sectional view of a micro speaker structure 10′, in accordance with some embodiments. As shown in FIG. 6, the micro speaker structure 10′ is similar to the micro speaker structure 10 described above, except that the second permanent magnetic element 180 is disposed above the air opening 108A instead of below the air opening 108A.

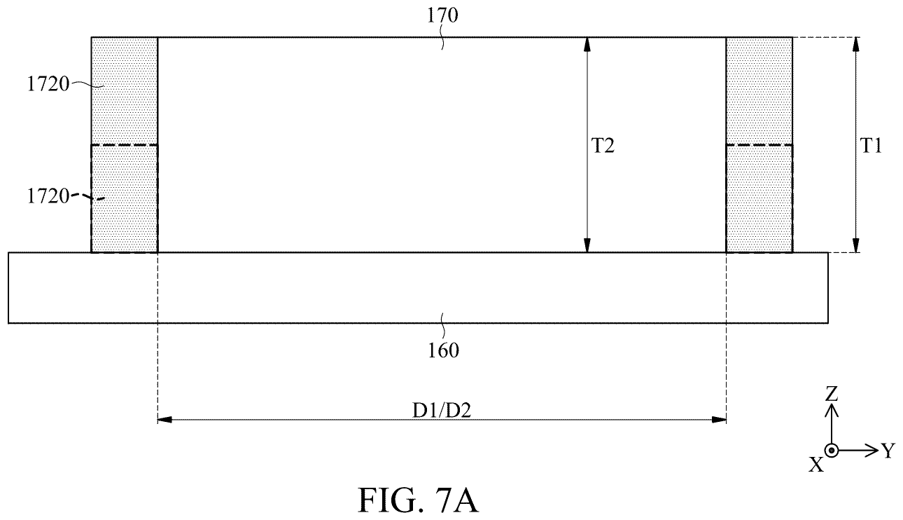

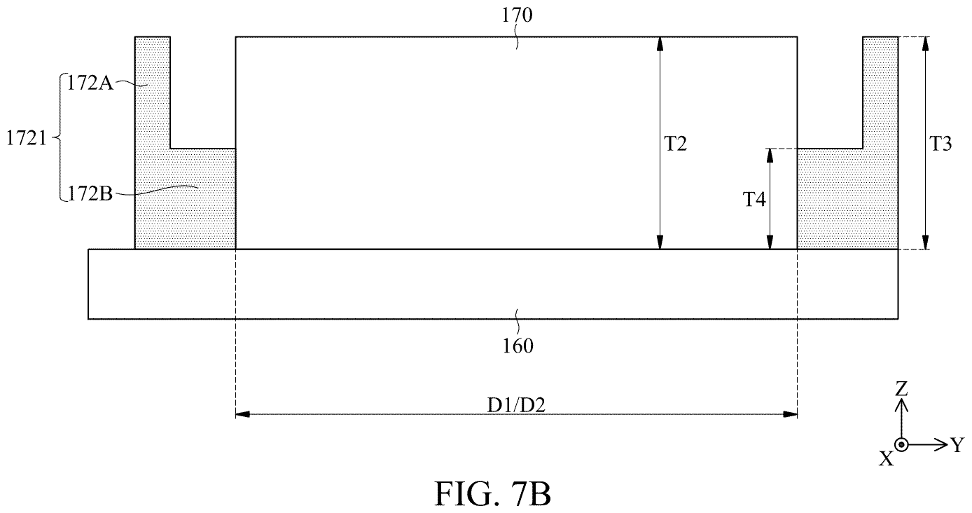

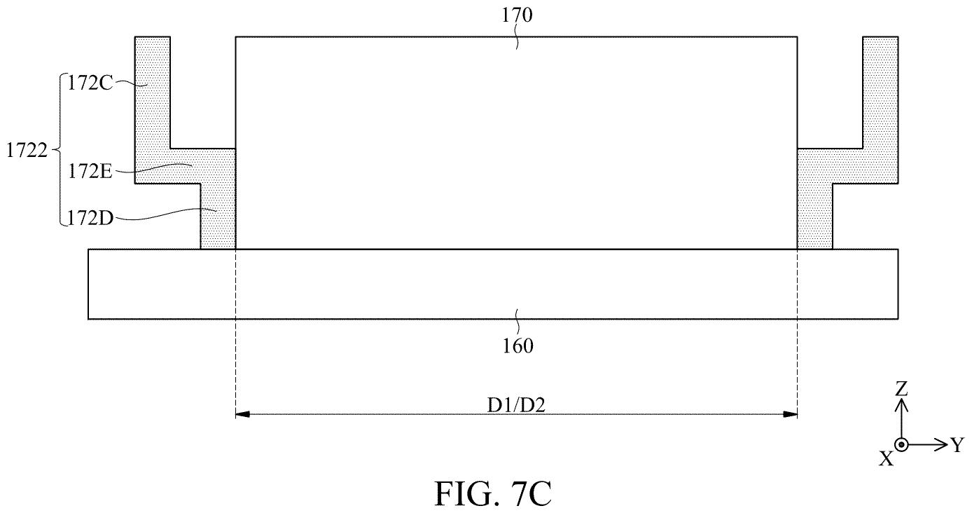

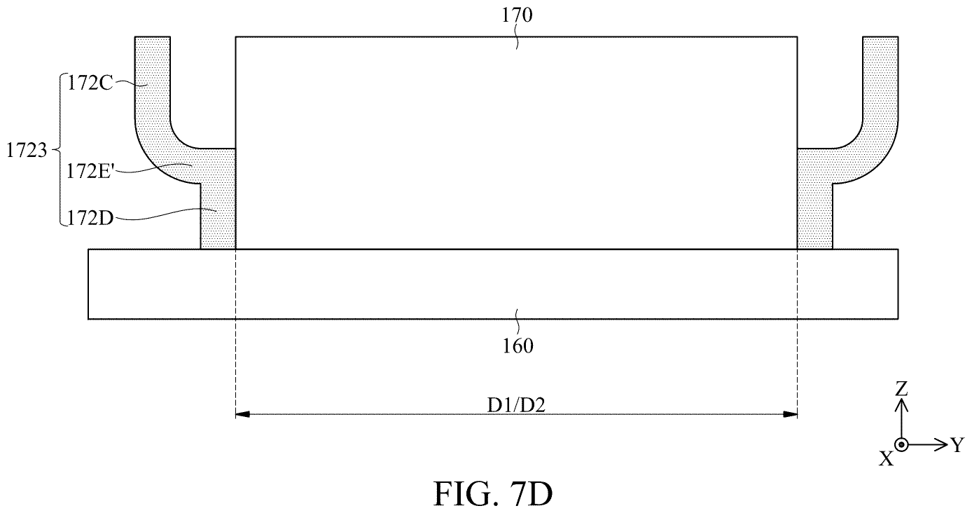

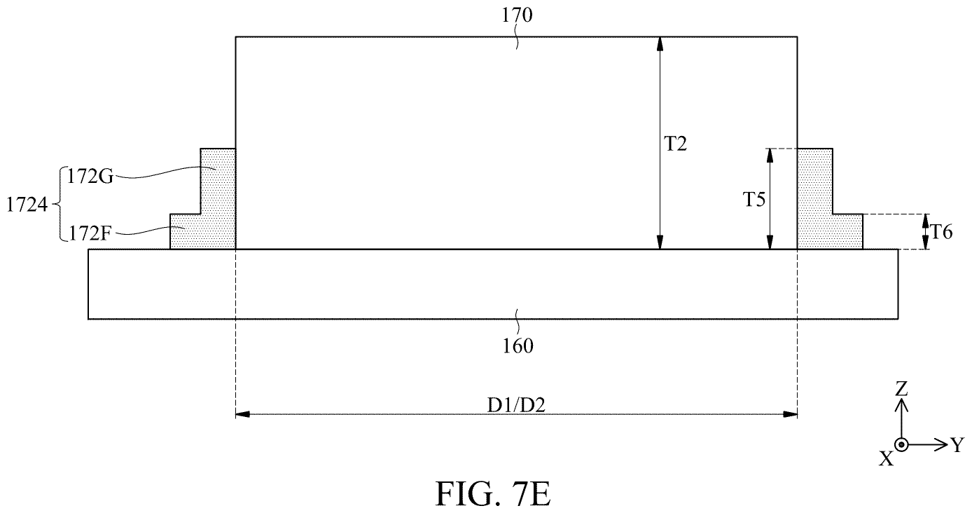

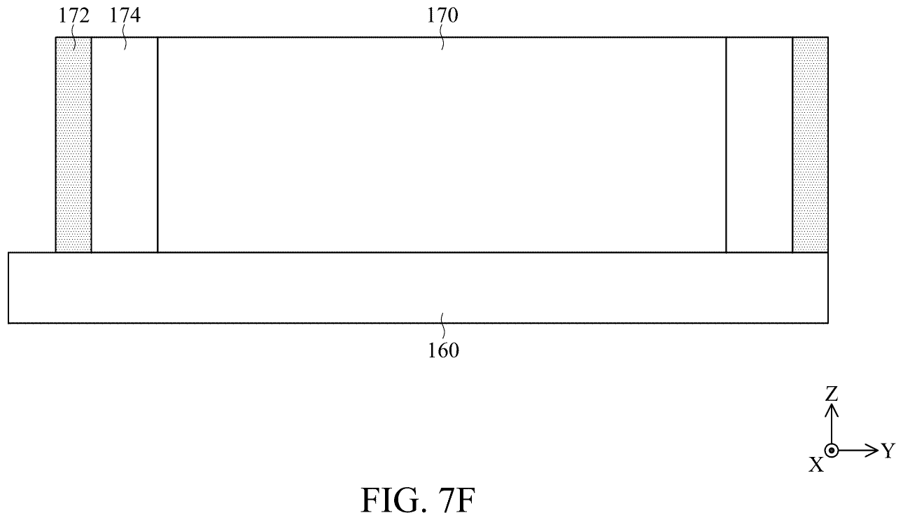

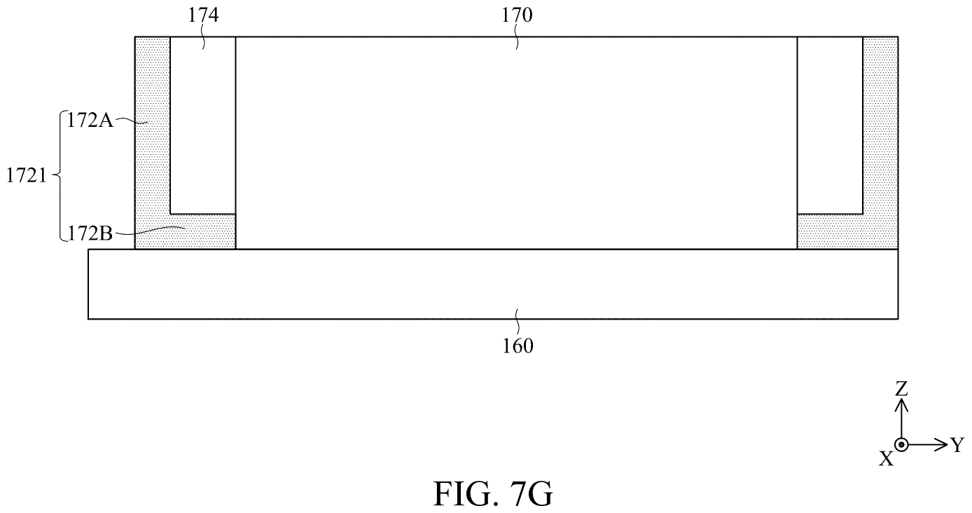

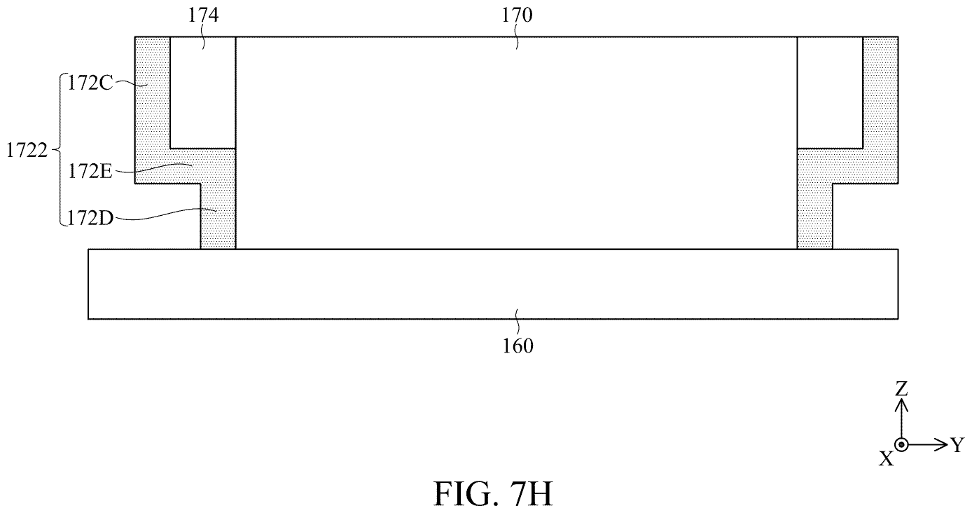

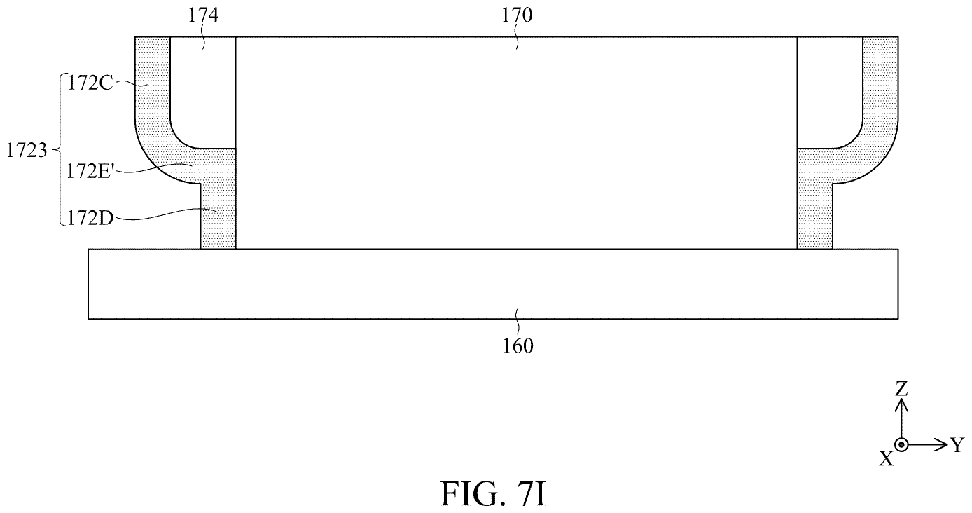

Many variations and/or modifications can be made to embodiments of the disclosure. For example, FIGS. 7A to 7I are schematic cross-sectional view of magnetic conductive elements (172, 1720, 1721, 1722, 1723, 1724) with various cross-sectional shapes and/or configurations, in accordance with some embodiments. It should be understood that these magnetic conductive elements with different cross-sectional shapes and/or configurations can be selected according to requirements to adjust the frequency response curve of the micro speaker structure (e.g., to increase the SPL at desired frequency range).

As shown in FIG. 7A, the structure of the magnetic conductive element 1720 is similar to that of the above magnetic conductive element 172 (i.e., it is also an ring-shaped structure), except that the inner diameter D1 of the magnetic conductive element 1720 is substantially equal to the diameter D2 of the first permanent magnetic element 170, so that the magnetic conductive element 172 (e.g., its inner sidewall) is in contact with the first permanent magnetic element 170 (e.g., its outer sidewall). In this way, the magnetic conductive element 1720 and the first permanent magnetic element 170 can be assembled together first, and then both are placed on the circuit board 160 at the same time. Therefore, the manufacturing time for the micro speaker structure can be shortened.

FIG. 7A also illustrates that the thickness T1 (e.g., in the Z-axis direction) of the magnetic conductive element 1720 may be equal to or different from (e.g., smaller than, as shown by the dotted line) the thickness T2 (e.g., in the Z-axis direction) of the first permanent magnetic element 170. In some embodiments, the ratio of the thickness T1 to the thickness T2 may be in the range of about 0.2 to about 1.

As shown in FIG. 7B, the magnetic conductive element 1721 includes a first (or outer) portion 172A and a second (or inner) portion 172B connected to each other, wherein the first portion 172A and the second portion 172B are both ring-shaped when viewed in the Z-axis direction, and the inner diameter D1 of the magnetic conductive element 1721 (e.g., the second/inner portion 172B) is substantially equal to the diameter D2 of the first permanent magnetic element 170 (similar to the example of FIG. 7A). In the example of FIG. 7B, the thickness T3 (e.g., in the Z-axis direction) of the first portion 172A is substantially equal to the T2 (e.g., in the Z-axis direction) of the first permanent magnetic element 170, and the thickness T4 (e.g., in the Z-axis direction) of the second portion 172B is less than the thickness T3 of the first portion 172A. In some embodiments, the ratio of the thickness T4 to the thickness T3 may be in the range of about 0.2 to about 1. In other embodiments, the thickness T3 (e.g., in the Z-axis direction) of the first portion 172A may be less than the T2 (e.g., in the Z-axis direction) of the first permanent magnetic element 170, so that the top surface of the magnetic conductive element 1721 is lower than the top surface of the first permanent magnetic element 170.

As shown in FIG. 7C, the magnetic conductive element 1722 includes a first (or outer) portion 172C, a second (or inner) portion 172D, and a third (or middle) portion 172E connecting the first portion 172C to the second portion 172D, wherein the first portion 172C, the second portion 172D, and the third portion 172E are both ring-shaped when viewed in the Z-axis direction, and the inner diameter D1 of the magnetic conductive element 1722 (e.g., the second/inner portion 172D) is substantially equal to the diameter D2 of the first permanent magnetic element 170 (similar to the example of FIG. 7A). In the example of FIG. 7C, the bottom of the first portion 172C is vertically spaced apart from the top surface of the circuit board 160, and the second portion 172D horizontally connect the bottom of the first portion 172C to the top of the third portion 172E. In this way, the magnetic conductive element 1722 has a structure consisting of a combination of an upper ring structure with a larger diameter and a lower ring structure with a smaller diameter. In some embodiments, the top surface of the upper ring structure of the magnetic conductive element 1722 (e.g., the first portion 172C) and the top surface of the first permanent magnetic element 170 are at the substantially same level when the magnetic conductive element 1722 is placed on the circuit board 160, but embodiments of the present application are not limited thereto (e.g., the top surface of the magnetic conductive element 1722 may also be lower than the top surface of the first permanent magnetic element 170).

As shown in FIG. 7D, the magnetic conductive element 1723 includes a first (or outer) portion 172C, a second (or inner) portion 172D, and a third (or middle) portion 172E′ connecting the first portion 172C to the second portion 172D, wherein the first portion 172C, the second portion 172D, and the third portion 172E′ are both ring-shaped when viewed in the Z-axis direction, and the inner diameter D1 of the magnetic conductive element 1723 (e.g., the second/inner portion 172D) is substantially equal to the diameter D2 of the first permanent magnetic element 170 (similar to the example of FIG. 7A). It should be noted that the magnetic conductive element 1723 is similar to the magnetic conductive element 1722 of FIG. 7D, except that the third (or middle) portion 172E′ of the magnetic conductive element 1723 is curved in cross-sectional view. Compared with the magnetic conductive element 1722 shown in FIG. 7D, the magnetic conductive element 1723 of this structure is easier to manufacture.

As shown in FIG. 7E, the magnetic conductive element 1724 includes a first (or outer) portion 172F and a second (or inner) portion 172G connected to each other, wherein the first portion 172F and the second portion 172G are both ring-shaped when viewed in the Z-axis direction, and the inner diameter D1 of the magnetic conductive element 1724 (e.g., the second/inner portion 172G) is substantially equal to the diameter D2 of the first permanent magnetic element 170 (similar to the example of FIG. 7A). In the example of FIG. 7E, the thickness T5 (e.g., in the Z-axis direction) of the second portion 172G is less than the T2 (e.g., in the Z-axis direction) of the first permanent magnetic element 170, and the thickness T6 (e.g., in the Z-axis direction) of the first portion 172F is less than the thickness T5 of the second portion 172G. In some embodiments, the ratio of the thickness T5 to the thickness T2 may be in the range of about 0.5 to about 0.8, and/or the ratio of the thickness T6 to the thickness T5 may be in the range of about 0.2 to about 0.8. Other ratios and ratio ranges are also possible.

In the examples of FIGS. 7F to 7I, the magnetic conductive elements (e.g., 172, 1721, 1722, 1723) are similar to the magnetic conductive elements (e.g., 172, 1721, 1722, 1723) discussed above with reference to FIGS. 2 and 7B-7D. The difference is that an adhesive material 174 is further formed (e.g., dispensed) in the gap between the outer sidewall of the first permanent magnetic element 170 and the magnetic conductive elements (e.g., 172, 1721, 1722, 1723). The adhesive material 174 may function to secure the magnetic conductive elements (e.g., 172, 1721, 1722, 1723) to facilitate the assembly of the micro speaker structure.

The adhesive material 174 can be any suitable adhesive material capable of joining the first permanent magnetic element 170 and the magnetic conductive element (e.g., 172, 1721, 1722, 1723). In some embodiments, the adhesive material 174 is a non-magnetic material and a non-magnetic conductive material, with or without magnetic conductive fillers (which include similar materials to the magnetic conductive element described above). In cases where the adhesive material 174 is filled with magnetic conductive fillers, both the magnetic conductive element (e.g., 172, 1721, 1722, 1723) and the adhesive material 174 help to constrain or concentrate the magnetic field (or magnetic field lines) generated by the first permanent magnetic element 170 near the coil 104, thereby enhancing the horizontal or planar magnetic field (i.e., the horizontal component of the magnetic field lines) passing through the coil 104.

It should be understood that the cross-sectional shapes and/or configurations of the magnetic conductive elements in FIGS. 5A to 5F are illustrative examples only, and are not intended to be, and should not be construed to be, limiting to the present disclosure. Many alternatives and modifications will be apparent to those skilled in the art, once informed by the present disclosure.

As described above, embodiments of the present disclosure provide a micro speaker structure and the method for forming the same. The micro speaker structure may include a magnetic conductive element on the circuit board surrounding the first permanent magnetic element to enhance the horizontal or planar magnetic field (i.e., the horizontal component of the magnetic field lines) passing through the coil. This enables the diaphragm embedding the coil to have a better frequency response, thereby improving the performance (e.g., SPL) of the micro speaker structure. Furthermore, the magnetic conductive element can be mounted on the circuit board during the packaging process of the micro speaker structure without the need for other complicated process.

The foregoing has outlined features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A micro speaker structure, comprising:
a substrate having a hollow chamber;
a diaphragm disposed over the substrate and covering the hollow chamber;
a coil embedded in the diaphragm;
a circuit board disposed on a bottom surface of the substrate;
a first permanent magnetic element disposed on the circuit board and in the hollow chamber; and
a magnetic conductive element disposed on the circuit board and surrounding the first permanent magnetic element, wherein the magnetic conductive element is a metal ring with magnetic permeability.

2. The micro speaker structure as claimed in claim 1, wherein a thickness of the magnetic conductive element is equal to a thickness of the first permanent magnetic element.

3. The micro speaker structure as claimed in claim 1, wherein an inner diameter of the magnetic conductive element is larger than a diameter of the first permanent magnetic element.

4. The micro speaker structure as claimed in claim 1, wherein the inner diameter of the magnetic conductive element is equal to the diameter of the first permanent magnetic element, and the magnetic conductive element is in contact with the first permanent magnetic element.

5. The micro speaker structure as claimed in claim 1, wherein the magnetic conductive element partially overlaps the coil in a plan view.

6. The micro speaker structure as claimed in claim 1, wherein a top surface of the magnetic conductive element and a top surface of the first permanent magnetic element are at the same level.

7. The micro speaker structure as claimed in claim 1, wherein the magnetic conductive element includes a first portion and a second portion connected to the first portion, wherein the second portion is closer to the first permanent magnetic element than the first portion, and a thickness of the second portion is less than a thickness of the first portion.

8. The micro speaker structure as claimed in claim 1, wherein the magnetic conductive element includes a first portion, a second portion, and a third portion, wherein the second portion is closer to the first permanent magnetic element than the first portion, a bottom of the first portion is vertically spaced apart from the circuit board, and the third portion connects the bottom of the first portion to a top of the second portion.

9. The micro speaker structure as claimed in claim 8, wherein the third portion of the magnetic conductive element is curved in a cross-sectional view.

10. The micro speaker structure as claimed in claim 1, wherein the magnetic conductive element includes a first portion and a second portion connected to the first portion, wherein the second portion is closer to the first permanent magnetic element than the first portion, and the thickness of the first portion is less than the thickness of the second portion.

11. The micro speaker structure as claimed in claim 1, further comprising:
an adhesive material disposed in a gap between an outer sidewall of the first permanent magnetic element and the magnetic conductive element.

12. The micro speaker structure as claimed in claim 1, wherein the circuit board has a cavity recessed from a top surface of the circuit board, and the cavity is configured to accommodate the first permanent magnetic element and the magnetic conductive element.

13. The micro speaker structure as claimed in claim 1, wherein the circuit board has at least one vent hole passing through the top surface and a bottom surface of the circuit board.

14. The micro speaker structure as claimed in claim 1, further comprising:
a lid wrapped around the substrate and the diaphragm, wherein the lid has an air opening that exposes a portion of a top surface of the diaphragm.

15. The micro speaker structure as claimed in claim 14, further comprising:
a second permanent magnetic element disposed on the lid, wherein the second permanent magnetic element is located below or above the air opening.

16. The micro speaker structure as claimed in claim 1, wherein the coil comprises a first metal layer and a second metal layer, and
wherein the first metal layer has a spiral structure surrounding a central axis of the diaphragm, and the second metal layer crosses over the spiral structure of the first metal layer and is electrically connected to the first metal layer.

17. A method for forming a micro speaker structure, comprising:
forming a coil on a substrate;
forming a diaphragm on the substrate to cover the coil;
forming a hollow chamber in the substrate, so that the coil structure is aligned with the hollow chamber in a plan view;
attaching a circuit board to the bottom surface of the substrate, wherein a permanent magnetic element is mounted on the circuit board and positioned in the hollow chamber; and
placing a magnetic conductive element on the circuit board to surround the permanent magnetic element, wherein the magnetic conductive element is a metal ring with magnetic permeability.

18. The method as claimed in claim 17, wherein the magnetic conductive element is placed on the circuit board so that the magnetic conductive element partially overlaps the coil in the plan view.

19. The method as claimed in claim 17, wherein the magnetic conductive element is placed on the circuit board so that the magnetic conductive element is laterally spaced apart from the permanent magnetic element.

20. The method as claimed in claim 17, wherein the magnetic conductive element is placed on the circuit board so that the top surface of the magnetic conductive element and a top surface of the permanent magnetic element are at the same level.
